(19) United States
(12) Patent Application Publication
(10) Pub. No.: US 2017/0142503 A1
(43) Pub. Date: May 18, 2017

(54) OPTICAL TRANSMITTER-RECEIVER AND LOOP-BACK METHOD

(71) Applicant: NEC Corporation, Tokyo (JP)

(72) Inventor: Daisuke TAKEI, Tokyo (JP)

(73) Assignee: NEC Corporation

(21) Appl. No.: 15/349,738

(22) Filed: Nov. 11, 2016

(30) Foreign Application Priority Data
Nov. 12, 2015 (JP) 2015-222140

(51) Int. Cl. H04Q 11/00; H04B 10/40

(52) U.S. Cl. CPC H04Q 11/0005; H04B 10/40; H04Q 2011/0039; H04Q 2011/0041; H04Q 2011/0015

(57) ABSTRACT

The present invention is intended to provide an optical transmitter-receiver that facilitates a diagnosis of components and devices in relation to an optical signal. An optical transmitter-receiver of the present invention includes a switch configured to switch a path for a transmitted optical signal and a path for a received optical signal so as to allow the transmitted optical signal to be looped back; and a controller configured to instruct the switch to perform the switching operation so as to allow the transmitted optical signal to be looped back.

This application is based upon and claims the benefit of priority from Japanese Patent Application No. 2015-222140, filed on Nov. 12, 2015, the disclosure of which is incorporated herein in its entirety by reference.

### TECHNICAL FIELD

The present invention relates to an optical transmitter-receiver and, in particular, relates to a technology for diagnosing the operation of components and devices constituting the optical transmitter-receiver.

### BACKGROUND ART

With the increase of demand for high-speed and large-capacity optical communication, the improvement of reliability of an optical transmission-reception system and the prompt recovery from a failure having occurred in such an optical transmission-reception system have been requested. Upon introduction of an optical transmission-reception system or upon occurrence of a failure in such an optical transmission-reception system, a configuration that enables a diagnosis of operation and an adjustment for each of components and devices constituting the system brings about not only the improvement of reliability of the system, but also the prompt recovery from the failure through the appropriate identification of a failure portion.

In Japanese Patent Application Publication No. 2008-53966, a structure that allows an optical loop-back module to be attached to the outside of an optical transceiver module for wavelength division multiplexing (WDM) communication is disclosed. This optical loop-back module includes an optical filter having a band pass characteristic in accordance with a wavelength grid in the WDM communication. This configuration enables an adjustment of the output light wavelength of a laser diode included in the optical transceiver module.

In Japanese Translation of PCT International Application Publication No. JP-T-2007-500458, an optical transmitter-receiver that enables diagnoses of components and devices constituting the transmitter-receiver by providing loop-back paths among electric-signal paths inside the optical transmitter-receiver is disclosed. Each of the loop-back paths is an electric-conductor path, and through such loop-back paths, the optical transmitter-receiver enables diagnoses of components and devices for use in the processes of electric signals, such as a laser driver and a transmitter eye opener at the transmission side, and a post-amplifier and a receiver eye opener at the reception side.

### SUMMARY

There is, however, a disadvantage described below in each of the technologies disclosed in Japanese Unexamined Patent Application Publication No. 2008-53966 and Japanese Translation of PCT International Application Publication No. JP-T-2007-500458.

With respect to the optical transceiver module disclosed in Japanese Unexamined Patent Application Publication No. 2008-53966, the optical loop-back module is needed to be externally attached thereto. Thus, members as well as time and labor are needed to replace optical fibers connected for normal transmission/reception with optical fibers for connection to the optical loop-back module. Further, securing a new space to install the optical loop-back module is also needed. Accordingly, it is difficult to readily diagnose components and devices.

In the transmitter-receiver disclosed in Japanese Translation of PCT International Application Publication No. JP-T-2007-500458, diagnoses of components and devices for use in the processes of electric signals can be made by providing electric conductor paths to establish electric-signal loop-back configurations inside the optical transmitter-receiver. Meanwhile, however, in the transmitter-receiver disclosed in Japanese Translation of PCT International Application Publication No. JP-T-2007-500458, any structure and any method for diagnosing components and devices for use in the process of an optical signal are not disclosed. Thus, diagnosing components and devices for use in the process of an optical signal on the basis of the transmitter-receiver disclosed in Japanese Translation of PCT International Application Publication No. JP-T-2007-500458 is difficult.

The present invention has been made in view of the above situations and is intended to provide an optical transmitter-receiver that facilitates a diagnosis of components and devices in relation to an optical signal.

An optical transmitter-receiver of the present invention includes a switch configured to switch a path for a transmitted optical signal and a path for a received optical signal so as to allow the transmitted optical signal to be looped back; and a controller configured to instruct the switch to perform the switching operation so as to allow the transmitted optical signal to be looped back.

A loop-back method of the present invention includes switching a path for a transmitted optical signal to allow the transmitted optical signal to be looped back, and switching a path for a received optical signal to allow the looped-back transmitted optical signal to be guided into the path for the received optical signal.

According to some aspects of the present invention, an optical transmitter-receiver that facilitates a diagnosis of components and devices in relation to an optical signal.

### BRIEF DESCRIPTION OF THE DRAWINGS

Exemplary features and advantages of the present invention will become apparent from the following detailed description when taken with the accompanying drawings in which:

FIG. 1 is a block diagram illustrating the structure of an optical transmitter-receiver according to a first embodiment of the present invention;

FIG. 2 is a block diagram illustrating the structure of an optical transmitter-receiver according to a second embodiment of the present invention;

FIG. 3 is a block diagram illustrating the structure of an optical transmitter-receiver according to a third embodiment of the present invention;

FIG. 4 is a flowchart illustrating the operation of an optical transmitter-receiver according to a third embodiment of the present invention; and

FIG. 5 is a block diagram illustrating the structure of a modification example of an optical transmitter-receiver according to a third embodiment of the present invention.

### EXEMPLARY EMBODIMENTS

Hereinafter, exemplary embodiments of the present invention will be described in detail with reference to the drawings. It is to be noted that, in order to practice the present invention, technically preferred restrictions are made on exemplary embodiments described below, but the scope of the present invention is not limited to the following exemplary embodiments.

### First Exemplary Embodiment

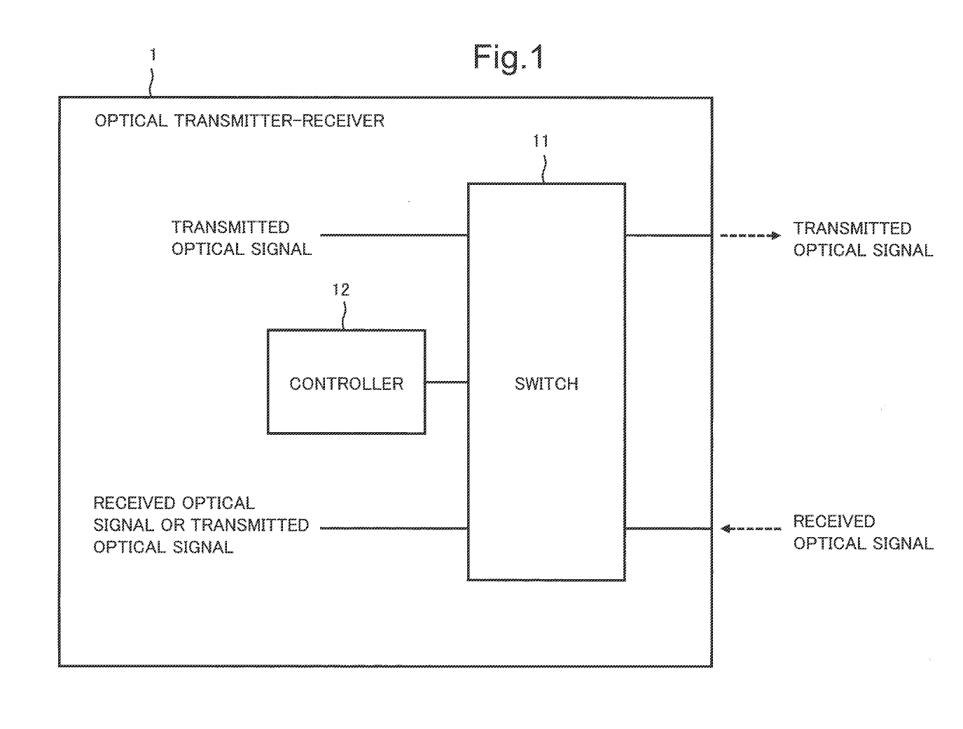

FIG. 1 is a block diagram illustrating the structure of an optical transmitter-receiver of a first exemplary embodiment of the present invention.

An optical transmitter-receiver 1 of the present embodiment includes a switch 11 and a controller 12. The switch 11 performs a switching operation of switching a path for a transmitted optical signal and a path for a received optical signal so as to allow the transmitted optical signal to be looped back. The controller 12 instructs the switch 11 to perform the switching operation so as to allow the transmitted optical signal to be looped back.

The optical transmitter-receiver 1 of the present embodiment includes, inside itself, the function of allowing the transmitted optical signal to be looped back, and thus, in the establishment of a loop-back configuration, any component and any work for interchanging optical fibers are not needed.

According to this embodiment, therefore, an optical transmitter-receiver that facilitates a diagnosis of components and devices in relation to an optical signal is provided.

### Second Exemplary Embodiment

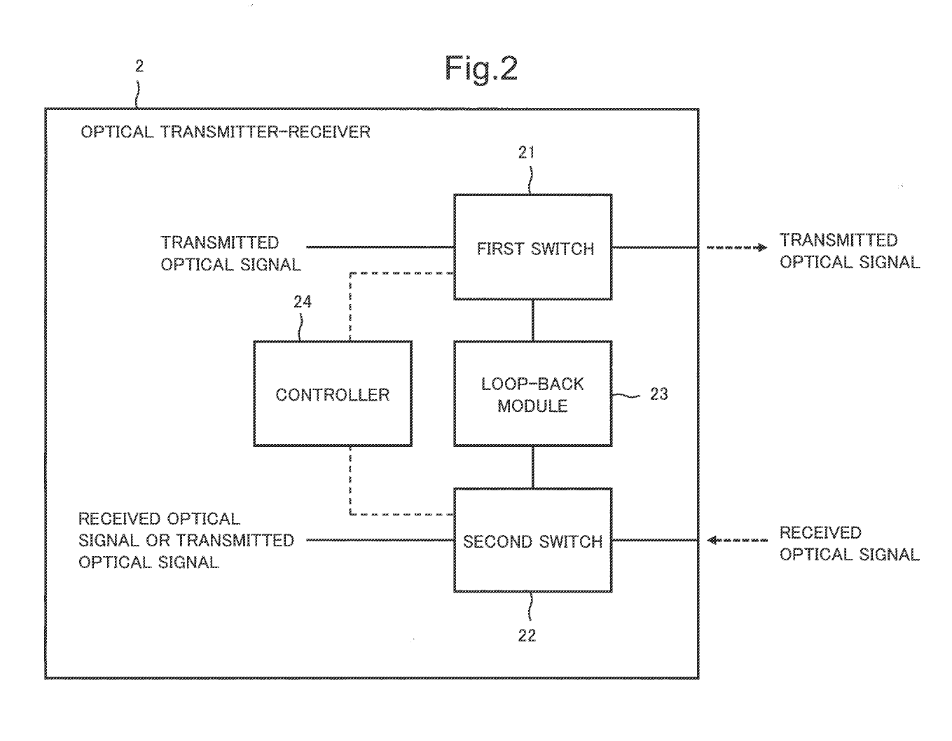

FIG. 2 is a block diagram illustrating the structure of an optical transmitter-receiver of a second exemplary embodiment of the present invention. An optical transmitter-receiver 2 of the present embodiment includes a first switch 21 and a second switch 22. The first switch 21 is disposed on a path for a transmitted optical signal and switches the path for the transmitted optical signal. The second switch 22 is disposed on a path for a received optical signal and switches the path for the received optical signal and a path for the transmitted optical signal. Further, the optical transmitter-receiver 2 includes a loop-back module 23. This loop-back module 23 interconnects the first switch 21 and the second switch 22. Moreover, the optical transmitter-receiver 2 includes a controller 24. This controller 24 instructs the first switch 21 and the second switch 22 to switch so as to allow the transmitted optical signal to be guided into the path for the received optical signal via the loop-back module 23.

The optical transmitter-receiver 2 of the present embodiment includes, inside itself, the function of allowing the transmitted optical signal to be looped back, and thus, in the establishment of a loop-back configuration, any component and any work for interchanging optical fibers are not needed.

According to this embodiment, therefore, an optical transmitter-receiver that facilitates a diagnosis of components and devices in relation to an optical signal is provided.

### Third Exemplary Embodiment

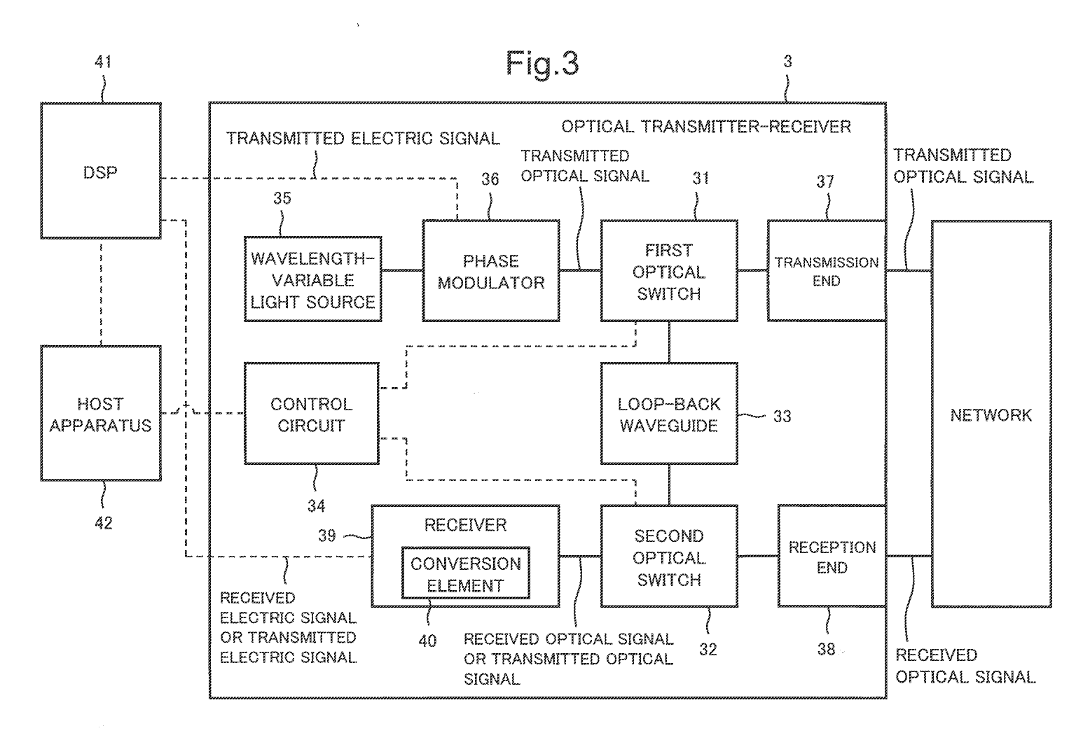

FIG. 3 is a block diagram illustrating the structure of an optical transmitter-receiver of a third exemplary embodiment of the present invention.

An optical transmitter-receiver 3 of the present embodiment includes a first optical switch 31, a second optical switch 32, a loop-back waveguide 33, and a control circuit 34. Further, the optical transmitter-receiver 2 includes a wavelength-variable light source 35, a phase modulator 36, and a transmission end 37. Moreover, the optical transmitter-receiver 2 includes a reception end 38 and a receiver 39. The receiver 39 includes a conversion element 40.

The first optical switch 31 is disposed between the phase modulator 36 and the transmission end 37 on a path for a transmitted optical signal. The first optical switch 31 outputs a transmitted optical signal from the phase modulator 36 to the transmission end 37 or the loop-back waveguide 33.

The second optical switch 32 is disposed on a path for a received optical signal between the reception end 38 and the receiver 39. The second optical switch 32 outputs, to the receiver 39, any one of the received optical signal, which is input from the reception end 38, and the transmitted optical signal, which is input from the first optical switch 31 via the loop-back waveguide 33.

The loop-back waveguide 33 transmits the transmitted optical signal, which is transferred via the first optical switch 31, to the second optical switch 32. An optical fiber or an optical space coupling element may be employed as the loop-back waveguide 33.

The control circuit 34 instructs the first optical switch 31 as to which of the transmission end 37 and the loop-back waveguide 33 the transmitted optical signal is to be output to, on the basis of an instruction from a host apparatus 42. Further, the control circuit 34 instructs the second optical switch 32 as to which of the received optical signal, having been input to the reception end 38, and the transmitted optical signal, having been input via the loop-back waveguide 33, is to be output to the receiver 39.

In this way, the optical transmitter-receiver 2 establishes a loop-back configuration that allows the transmitted optical signal to be transferred to the receiver 39 via the first optical switch 31, the loop-back waveguide 33, and the second optical switch 32 on the basis of the instruction from the host apparatus 42.

The control circuit 34 is realized by causing an arithmetic operation circuit, such as a central processing unit (CPU), to execute a program.

The wavelength-variable light source 35 emits light having a desired wavelength for forming the transmitted optical signal. The use of a laser diode in the wavelength-variable light source 35 enables the light emitted by the wavelength-variable light source 35 to be changed into laser light having a desired wavelength.

In order to generate the transmitted optical signal, the phase modulator 36 phase-modulates light emitted from the wavelength-variable light source 35 using a transmitted electric signal. This transmitted electric signal is generated and transferred by a digital signal processor (DSP) 41.

The transmitted optical signal, having been transferred via the first optical switch 31, is output from the transmission end 37 to a transmission line coupled to a network. The transmission end 37 includes a connector coupled to optical fibers constituting the transmission line.

A received optical signal transmitted from the transmission line, coupled to the network, is input to the reception end 38. The reception end 38 includes a connector coupled to optical fibers constituting the transmission line.

The receiver 39 includes the conversion element 40. The conversion element 40 converts the received optical signal, which is input via the reception end 38 and the second optical switch 32, or the transmitted optical signal, which is input via the loop-back waveguide 33 and the second optical switch 32, into an electric signal. A photodiode may be employed as the conversion element 40.

The DSP 41 generates the transmitted electric signal, which is an information source of the transmitted optical signal transmitted from the optical transmitter-receiver 3, on the basis of information from the host apparatus 42, and then, outputs the relevant transmitted electric signal to the phase modulator 36. Further, the DSP 41 performs processing on a received electric signal resulting from a conversion from the received optical signal by the receiver 39. Further, the DSP 41 may be configured to have the function of a comparator for comparing the transmitted electric signal, generated by the DSP 41, with a transmitted electric signal resulting from a conversion from the looped-back transmitted optical signal by the receiver 39. These configurations enable a diagnosis of components and devices related to an optical signal and included in the wavelength-variable light source 35, the phase modulator 36, and the receiver 39.

In addition, for example, a configuration that allows the first optical switch 31 to be disposed on a path between the wavelength-variable light source 35 and the phase modulator 36 so as to establish a loop-back configuration excluding the phase modulator 36 can be made. In this case, the DSP 41 is able to diagnose components and devices in relation to an optical signal in a configuration separated from the phase modulator 36.

The DSP 41 may be independently installed, and further may be incorporated in the host apparatus 42 or the optical transmitter-receiver 3.

The host apparatus 42 instructs the control circuit 34 as to whether the transmitted optical signal is to be output to the network or to be looped back. Further, the host apparatus 42 provides the DSP 41 with information to be transmitted. Further, the host apparatus 42 acquires, from the DSP 41, a result of the processing on the received electric signal and a result of the comparison between the transmitted electric signal and the looped-backed transmitted electric signal.

The host apparatus 42 is able to be configured using an information processing device, such as a personal computer (PC) or a server.

Communication between the host apparatus 42 and the optical transmitter-receiver 3 is able to be made using management data input output (MDIO) communication. In addition, the communication between the host apparatus 42 and the optical transmitter-receiver 3 is not limited to the MDIO communication. Another digital or analog communication, such as serial peripheral interface (SPI) communication or inter-integrated circuit (I2C) communication, is also able to be applied to the above communication.

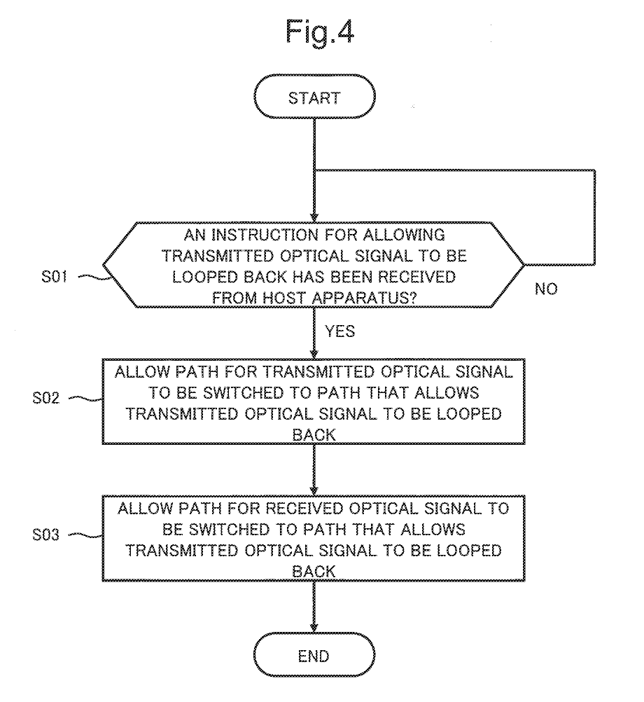

FIG. 4 is a flowchart illustrating the operation of the optical transmitter-receiver 3 of the present embodiment. The flowchart in FIG. 4 is able to be started in a state in which the optical transmitter-receiver 3 is performing normal transmitting/receiving operation.

In step S01, the control circuit 34 determines whether or not an instruction for allowing the transmitted optical signal to be looped back has been received from the host apparatus 42. When the instruction has been received (YES in step S01), the control circuit 34 causes the process flow to proceed to step S02. Otherwise (NO in step S01), the control circuit 34 repeats the process in step S01.

In step S02, the control circuit 34 instructs the first optical switch 31 to allow the path for the transmitted optical signal to be switched to a path that allows the transmitted optical signal to be looped back. Upon receipt of the instruction, the first optical switch 31 switches the path for the transmitted optical signal from a path connected to the transmission end 37 to a path connected to the loop-back waveguide 33.

In step S03, the control circuit 34 instructs the second optical switch 32 to allow the path for the received optical signal to be switched to a path that allows the transmitted optical signal to be looped back. Upon receipt of the instruction, the second optical switch 32 disconnects the path for the received optical signal from the reception end 38, performs switching so as to allow the transmitted optical signal transferred from the loop-back waveguide 33 to be guided into the path for the received optical signal, and then, terminates the process flow.

In addition, the control circuit 34 is able to approximately simultaneously issue both of the instruction to the first optical switch 31 in step S02 and the instruction to the second optical switch 32 in step S03. Further, the order in which the process in step S02 and the process in step S03 are performed may be reversed.

In addition, the optical transmitter-receiver 3 of the present embodiment is also able to establish an electric-signal loop-back configuration by disposing an electric-signal switch on an electric-signal path and further disposing an electric-signal loop-back module. This configuration enables a diagnosis of components, devices, and wirings in relation to an electric signal to be combined with the diagnosis of components and devices in relation to the optical signal. For example, in FIG. 3, a configuration that allows the transmitted electric signal transferred from the DSP 41 to be looped back at a position anterior to the phase modulator 36 into an electric-signal path located posterior to the receiver 39 so as to be input to the DSP 41 can be made. This configuration enables a diagnosis of a state of wirings for the electric signal inside the optical transmitter-receiver 3.

In addition, in the optical transmitter-receiver 3 of the present embodiment, an optical splitter may be used in substitution for the optical switch. For example, an optical splitter that branches 90% of the transmitted optical signal into the transmission end 37 and branches 10% of the transmitted optical signal into the loop-back waveguide 33 may be used in substitution for the first optical switch 31. Upon receipt of an instruction for instructing the transition into a diagnostic mode from the host apparatus 42, the control circuit 34 instructs the second optical switch 32 to disconnect the received optical signal from the reception end 38 and transfer the transmitted optical signal from the loop-back waveguide 33 to the receiver 39. This configuration enables an establishment of a loop-back configuration in relation to the transmitted optical signal.

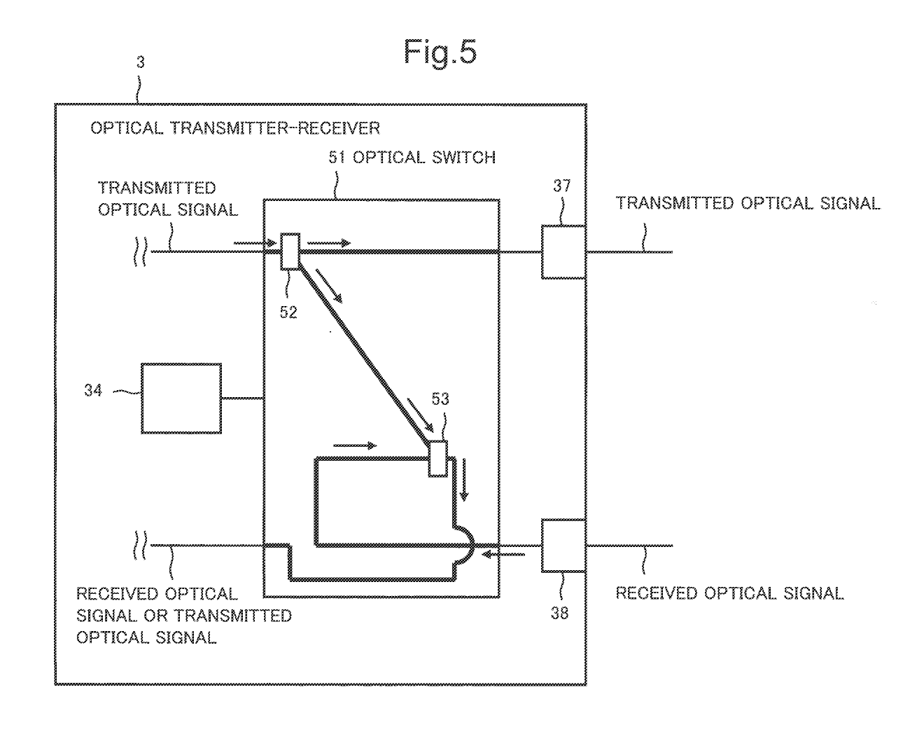

FIG. 5 is a block diagram illustrating the structure of a modification example of the optical transmitter-receiver 3 of the present embodiment. The optical transmitter-receiver 3 can be structured so as to include an integration type optical switch 51 provided with a switch 52 and a switch 53. The switch 52 performs switching of the transmitted optical signal, and the switch 53 performs switching between the received optical signal and the looped-back transmitted optical signal. Each of the switches 52 and 53 can be realized by, but is not limited to, for example, a mirror, a shutter, or a reverse delta-beta (Δβ) directional coupler that controls a waveguide path using a voltage.

In addition, the optical transmitter-receiver 3 of the present embodiment is only required to be structured to perform switching between the path for the transmitted optical signal and the path for the received optical signal so as to allow the transmitted optical signal to be looped back, and is not limited to the structures shown in FIGS. 3 and 5.

The optical transmitter-receiver 3 of the present embodiment can be applied to a digital coherent optical transmitter-receiver. Further, the optical transmitter-receiver 3 can be applied to a pluggable optical transmitter-receiver. In addition, the optical transmitter-receiver 3 is not limited to the digital coherent optical transmitter-receiver, and can also be applied to an optical transmitter-receiver of an intensity modulation type and an optical transmitter-receiver of a direct detection type.

As described above, the optical transmitter-receiver 3 of the present embodiment has the function of allowing the transmitted optical signal to be looped back inside the optical transmitter-receiver 3 itself, and thus, this configuration of the optical transmitter-receiver 3 makes it unnecessary to interchange optical fibers when a loop-back configuration is established. Thus, the configuration of the optical transmitter-receiver 3 makes the members, time, and labor, which are needed for the interchange of optical fibers, unnecessary, and further makes the securing of a space unnecessary. Further, the configuration of the optical transmitter-receiver 3 enables a diagnosis and an adjustment in a loop-back configuration to be made in accordance with remote control from the external host apparatus, and thus, further enables the diagnosis and the adjustment in the loop-back configuration to be automatically and readily made.

Examples of situations in which the diagnosis and the adjustment in the loop-back configuration are made include, but are not limited to, an operation testing and an initial setting at the time of shipment from a factory, an initial setting at the time of installation of a communication system, a re-setting and calibration at the time of a system operation, and a failure diagnosis at the time of occurrence of a failure. For example, in the operation testing at the time of shipment from a factory, the configuration of the optical transmitter-receiver 3 does not need any external component and any measurement tool, and thus, enables not only the reduction of production cost, but also the improvement of quality stability. Further, in the failure diagnosis at the time of occurrence of a failure, the configuration of the optical transmitter-receiver 3 is effective in the identification of a failure point, such as an identification as to whether or not the failure point exists in components and devices related to the optical signal and included in the optical transmitter-receiver 3, an identification as to whether or not the failure point exists in components and devices included in other transmission systems, or an identification as to whether or not the failure point exists in the host apparatus.

As described above, according to the present embodiment, an optical transmitter-receiver that facilitates a diagnosis of components and devices in relation to an optical signal is provided.

It is to be noted that the present invention is not limited to the foregoing embodiments, and various modifications may be made on the forgoing embodiments within the scope of the invention set forth in appended claims. Naturally, however, the modifications are included in the scope of the present invention.

In addition, some or all of the above described exemplary embodiments can be also described as, but are not limited to, the following Supplementary notes.

(Supplementary Note 1)

An optical transmitter-receiver including

a switch configured to switch a path for a transmitted optical signal and a path for a received optical signal so as to allow the transmitted optical signal to be looped back; and

a controller configured to instruct the switch to perform the switching operation so as to allow the transmitted optical signal to be looped back.

(Supplementary Note 2)

The optical transmitter-receiver according to supplementary note 1,

wherein the switch includes a first switch disposed on the path for the transmitted optical signal and configured to switch the path for the transmitted optical signal; a second switch disposed on the path for the received optical signal and configured to switch the path for the received optical signal and a path for the transmitted optical signal; and a loop-back module configured to interconnect the first switch and the second switch, and

wherein the controller instructs the first switch and the second switch to switch so as to allow the transmitted optical signal to be guided into the path for the received optical signal via the loop-back module.

(Supplementary Note 3)

The optical transmitter-receiver according to supplementary note 1 or supplementary note 2, wherein the controller instructs the switch upon receipt of an instruction from a host apparatus.

(Supplementary Note 4)

The optical transmitter-receiver according to any one of supplementary notes 1 to 3 further including a converter configured to convert the transmitted optical signal into an electric signal, and a comparator configured to compare the electric signal, having been converted by the converter, with an electric signal that is a source of the transmitted optical signal.

(Supplementary Note 5)

The optical transmitter-receiver according to supplementary note 4, wherein the comparator includes a digital signal processor.

(Supplementary Note 6)

The optical transmitter-receiver according to any one of supplementary notes 2 to 5, wherein each of the first switch and the second switch includes an optical switch or an optical splitter.

(Supplementary Note 7)

The optical transmitter-receiver according to any one of supplementary notes 2 to 6, wherein the loop-back module includes an optical fiber or an optical space coupling element.

(Supplementary Note 8)

A loop-back method including switching a path for a transmitted optical signal to allow the transmitted optical signal to be looped back, and switching a path for a received optical signal to allow the looped-back transmitted optical signal to be guided into the path for the received optical signal.

(Supplementary Note 9)

The loop-back method according to supplementary note 8 further including comparing an electric signal that is a source of the transmitted optical signal with an electric signal resulting from converting the looped-back transmitted optical signal.

(Supplementary Note 10)

The loop-back method according to supplementary note 9, wherein the comparing is made by a digital signal processor.

(Supplementary Note 11)

The loop-back method according to any one of supplementary notes 8 to 10, wherein the switching of the path is performed by an optical switch or an optical splitter.

(Supplementary Note 12)

The loop-back method according to any one of supplementary notes 8 to 11, wherein the loop-back is performed by an optical fiber or an optical space coupling.

The previous description of embodiments is provided to enable a person skilled in the art to make and use the present invention.

Moreover, various modifications to these exemplary embodiments will be readily apparent to those skilled in the art, and the generic principles and specific examples defined herein may be applied to other embodiments without the use of inventive faculty.

Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

### REFERENCE SIGNS LIST

1, 2, 3: OPTICAL TRANSMITTER-RECEIVER
11: SWITCH
12, 24: CONTROLLER
21: FIRST SWITCH
22: SECOND SWITCH
23: LOOP-BACK MODULE
24: CONTROLLER
31: FIRST OPTICAL SWITCH
32: SECOND OPTICAL SWITCH
33: LOOP-BACK WAVEGUIDE
34: CONTROL CIRCUIT
35: WAVELENGTH-VARIABLE LIGHT SOURCE
36: PHASE MODULATOR
37: TRANSMISSION END
38: RECEPTION END
39: RECEIVER
40: CONVERSION ELEMENT
41: DSP
42: HOST APPARATUS
51: OPTICAL SWITCH
52, 53: SWITCH

1. An optical transmitter-receiver including
a switch configured to switch a path for a transmitted optical signal and a path for a received optical signal so as to allow the transmitted optical signal to be looped back; and
a controller configured to instruct the switch to perform the switching operation so as to allow the transmitted optical signal to be looped back.

2. The optical transmitter-receiver according to claim 1,
wherein the switch includes a first switch disposed on the path for the transmitted optical signal and configured to switch the path for the transmitted optical signal; a second switch disposed on the path for the received optical signal and configured to switch the path for the received optical signal and a path for the transmitted optical signal; and a loop-back module configured to interconnect the first switch and the second switch, and
wherein the controller instructs the first switch and the second switch to switch so as to allow the transmitted optical signal to be guided into the path for the received optical signal via the loop-back module.

3. The optical transmitter-receiver according to claim 1, wherein the controller instructs the switch upon receipt of an instruction from a host apparatus.

4. The optical transmitter-receiver according to claim 1 further including a converter configured to convert the transmitted optical signal into an electric signal, and a comparator configured to compare the electric signal, having been converted by the converter, with an electric signal that is a source of the transmitted optical signal.

5. The optical transmitter-receiver according to claim 4, wherein the comparator includes a digital signal processor.

6. The optical transmitter-receiver according to claim 2, wherein each of the first switch and the second switch includes an optical switch or an optical splitter.

7. The optical transmitter-receiver according to claim 2, wherein the loop-back module includes an optical fiber or an optical space coupling element.

8. A loop-back method including switching a path for a transmitted optical signal to allow the transmitted optical signal to be looped back, and switching a path for a received optical signal to allow the looped-back transmitted optical signal to be guided into the path for the received optical signal.

9. The loop-back method according to claim 8 further including comparing an electric signal that is a source of the transmitted optical signal with an electric signal resulting from converting the looped-back transmitted optical signal.

10. The loop-back method according to claim 9, wherein the comparing is made by a digital signal processor.

11. An optical transmitter-receiver including
switch means for switching a path for a transmitted optical signal and a path for a received optical signal so as to allow the transmitted optical signal to be looped back; and
control means for instructing the switch to perform the switching operation so as to allow the transmitted optical signal to be looped back.
